(19) United States
(12) Patent Application Publication
(10) Pub. No.: US 2009/0049151 A1
(43) Pub. Date: Feb. 19, 2009

(54) TIMED MESSAGE REDIRECTION FOR HIGH PRIORITY INSTANT MESSAGES

(75) Inventor: William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/838,661

(22) Filed: Aug. 14, 2007

(51) Int. Cl. G06F 15/16

(52) U.S. Cl. 709/207

(57) ABSTRACT

Embodiments of the present invention address deficiencies of the art in respect to high priority instant message handling and provide a method, system and computer program product for time message redirection for high priority instant messages. In one embodiment of the invention, a method for the timed redirection of a high priority instant message can be provided. The method can include transmitting an instant message to a primary recipient, and redirecting the instant message to a set of secondary recipients in sequence, each of the secondary recipients receiving the redirected instant message one at a time at pre-programmed intervals of time. In response to receiving a response from the primary recipient or one of the secondary recipients, however, all redirects of the instant message can be cancelled.

### BACKGROUND OF THE INVENTION

1. Field of the Invention

The present invention relates to the field of instant messaging and more particularly to high priority instant message handling in an instant messaging environment.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include document libraries, instant messaging, chat rooms, and application sharing.

Conventional collaborative computing includes combinations of collaborative technologies in order to provide a means for members of a collaborative community to pool their strengths and experiences to achieve a common goal. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment. Roles are names given to the people in the environment which dictate access to the resources and tools within the environment as well as define the behavior of the community members.

Amongst often used collaborative components in a collaborative environment, instant messaging remains of paramount importance. In an instant messaging environment, one or more collaborators can exchange messages shown to be arranged in a single space visible by all. Thus, the instant messaging component aims to mimic a human-to-human conversation in which the real-time nature of the exchange of written conversation between participants can be limited only by the speed in which participants can read, digest and reply to the contributions of other contributors who are party to the instant messaging session.

Generally, launching collaborative interactions with a target collaborator or collaborators involves simply selecting the desired collaborators through an instant messenger interface and commanding the creation of an instant messaging session. To the extent that the selected collaborator or collaborators are available, instantaneous interactions can occur. However, where the selected collaborator or collaborators are not available, no response will be apparent through the creation of the instant messaging session. In the latter circumstance, the instant messaging session can be dismissed or the instant messaging session can remain open until such time as the selected collaborator becomes available.

Even still, oftentimes a collaborator in an instant messaging environment must connect in an instant messaging session with a specific co-collaborator with great expediency. In this circumstance, it is not acceptable to wait until the selected collaborator or collaborators become available. Rather, to expedite matters, the initiating collaborator can attempt to establish other instant messaging sessions with related collaborators in an attempt to cause the intended collaborator to become aware of the initiator's overtures. At some point, the intended collaborator will become aware of the need to engage in an instant messaging session though many of the other collaborators solicited in the interim may not be aware.

In consequence, while the initiator may initially have been frustrated by a lack of response by any of the targeted collaborators, suddenly, a rash of responses can be had complicating the interactions and requiring the initiator to explain that the intended collaborator already has been reached. To avoid the sudden rash of responses, it has become customary for the initiator to call off the request to locate the intended collaborator with a series of “never mind” or “nvm” posting to each different launched instant messaging session with each different collaborator.

### BRIEF SUMMARY OF THE INVENTION

Embodiments of the present invention address deficiencies of the art in respect to high priority instant message handling and provide a novel and non-obvious method, system and computer program product for time message redirection for high priority instant messages. In one embodiment of the invention, a method for the timed redirection of a high priority instant message can be provided. The method can include transmitting an instant message to a primary recipient, and redirecting the instant message to a set of secondary recipients in sequence, each of the secondary recipients receiving the redirected instant message one at a time at pre-programmed intervals of time. In response to receiving a response from the primary recipient or one of the secondary recipients, however, all redirects of the instant message can be cancelled.

In one aspect of the embodiment, redirecting the instant message to a set of secondary recipients in sequence can include prompting for a list of secondary recipients and a timeout value. Subsequently, a first one of the secondary recipients can be selected and the instant message can be redirected to the first one of the secondary recipients. Later, in response to an elapsed period of time exceeding the timeout value, a second one of the secondary recipients can be selected and the instant message can be redirected to the second one of the secondary recipients while the display of the redirected message can be vanished for the first one of the secondary recipients.

In another embodiment of the invention, an instant messaging data processing system can be provided. The system can include an instant messenger configured for communicative coupling to instant messaging recipients. The system also can include a directory of the instant messaging recipients. Finally, the system can include time instant message redirection logic. The logic can include program code enabled to redirect a transmitted instant message to secondary ones of the instant messaging recipients in the directory, each of the secondary ones of the instant messaging recipients receiving the redirected instant message one at a time at a pre-programmed interval of time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a timed message redirection of a high priority instant message;

FIG. 2 is a schematic illustration of an instant messaging system configured for time message redirection for high priority instant messages; and,

FIG. 3 is a flow chart illustrating a process for time message redirection for high priority instant messages.

### DETAILED DESCRIPTION OF THE INVENTION

Embodiments of the present invention provide a method, system and computer program product for timed instant message redirection. In an embodiment, an instant message can be composed and transmitted to a primary recipient. Upon command, the instant message further can be designated for redirection to one or more other secondary recipients in sequence only after a specified period of non-responsiveness upon receipt of the redirected instant message by a given secondary recipient. Once either the primary recipient or any of the secondary recipients have responded to the redirected instant message, no more instant messages need be redirected to the other secondary recipients. In this way, the attention of the primary recipient can be acquired in an orderly fashion without risking a flood of needless responses by the secondary recipients or the transmission of never mind instant messages.

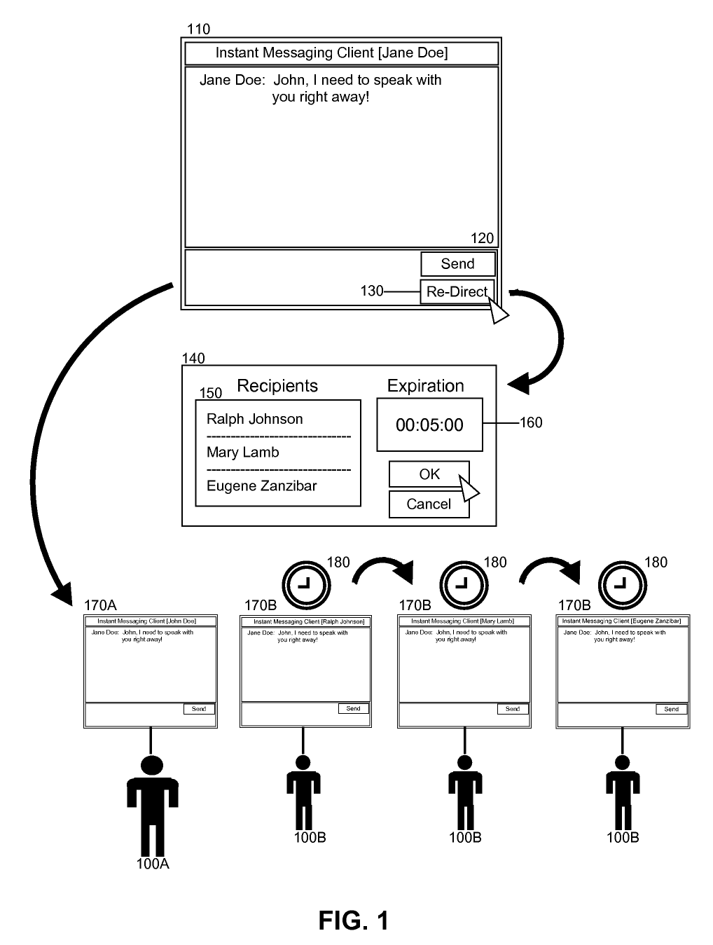

In further illustration, FIG. 1 pictorial depicts the timed message redirection of a high priority instant message. As shown in FIG. 1, an instant message 120 can be composed within instant messenger 110 and forwarded to coupled instant messenger 170A to grab the attention of a designated primary recipient 100A. After a period of non-responsiveness has elapsed, a redirect control 130 can be activated in the instant messenger 110 to redirect the instant message 120 to other coupled instant messengers 170B for respective designated secondary recipients 100B. In this regard, in response to the activation of the redirect control 130, a redirect dialog 140 can be displayed to include a list of secondary recipients 150 and a specified expiration time 160.

Thereafter, the instant message 120 can be sequentially forwarded to each selected secondary recipient 100B. Specifically, a first selected secondary recipient 100B can receive a redirected copy of the instant message 120 and a clock 180 can commence. When the elapsed time specified by the clock 180 exceeds the specified expiration time, the redirected copy of the instant message 120 in the instant messenger 170B for the first secondary recipient can be vanished and a copy of the instant message 120 can be redirected for display in an instant messenger 170B for a next selected secondary recipient 100B. The process can repeat until either the primary recipient 100A or the then active secondary recipient 100B replies. If no replies occur for any of the secondary recipients 100B, when no further secondary recipients 100B remain for redirection either the process can begin anew with the first selected secondary recipient 100B or the process can end.

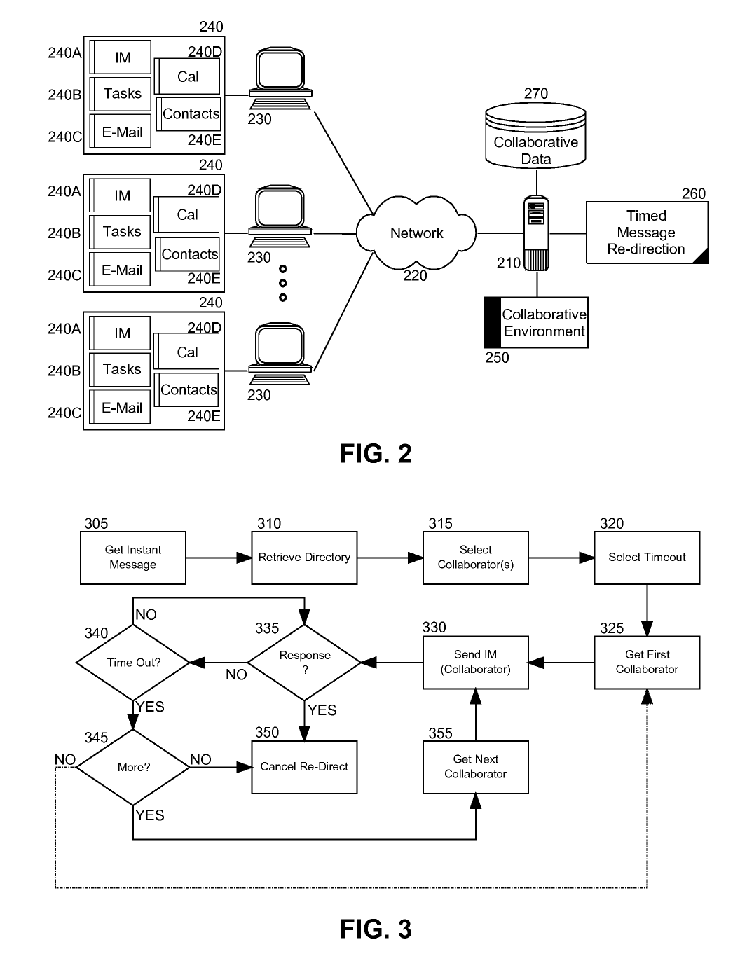

The process described herein can be performed in an instant messaging data processing system. In more particular illustration, FIG. 2 schematically depicts an instant messaging system configured for time message redirection for high priority instant messages. The system can include a host server 210 configured for communicative coupling to one or more collaborative clients 230 over computer communications network 220. The host server 210 can support the operation of a collaborative environment 250 serving each of the collaborative clients 230 and managing collaborative data 270 for the collaborative clients 230.

Each of the collaborative clients 230 can provide a collaborative application 240. The collaborative application 240 can include, for example, an instant messenger 240A, a task manager 240B, an e-mail manager 240C, a calendar 240D and a contact manager 240E. It will be recognized by the skilled artisan, however, that any or all of the functional portions of the collaborative application 240 can be disposed in host server 210 as part of the collaborative environment 250 and provided to a lightweight client in collaborative client 230 such as a Web browser over the computer communications network 220.

Notably, timed message redirection logic 260 can be coupled to the collaborative environment 250 through host server 210. The logic 260 can include program code enabled to sequentially redirect an instant message from a designated primary recipient, to one or more secondary recipients. In this regard, the logic 260 taking a specified time-out as a parameter, can collect a list of secondary recipients and serially redirect the instant message to one of the secondary recipients in the list at a time. For a given secondary recipient, if an elapsed time from redirection exceeds the time-out without receiving a response from either the primary recipient or the given secondary recipient, the instant message can be redirected to a next one of the secondary recipients in the list whilst removing the instant message from the queue of the given secondary recipient.

In further illustration of the operation of the logic 260, FIG. 3 is a flow chart illustrating a process for time message redirection for high priority instant messages. Beginning in block 305, an instant message sent to a primary collaborator can be selected and in block 310, a directory can be retrieved of available collaborators in the instant messaging system. In block 315, one or more collaborators in the directory can be selected as secondary collaborators. Also, in block 320, a time-out value can be specified for redirecting the instant message.

In block 325, a first of the selected secondary collaborators can be chosen to receive the redirected instant message. Thereafter, in block 330, the redirected instant message can be sent to the first of the selected secondary collaborators. In decision block 335, it can be determined whether or not a response has been received either from the primary collaborator or the first of the selected secondary collaborators. If so, further redirection of the instant message can be canceled in block 350. Otherwise, in decision block 340, it can be determined whether a timeout condition has arisen. If not, the process can return to decision block 335. However, if a timeout condition has arisen, the redirected instant message can be removed from view in the first of the selected secondary collaborators and the process can continue through decision block 345.

In decision block 345, it can be determined if additional secondary collaborators remain to be processed. If so, in block 355 a next of the selected secondary collaborators can be chosen to receive the redirected instant message and in block 330 the redirected instant message can be sent to the next of the selected secondary collaborators as before. The process can continue through decision block 335 until either a response is received from either the primary or any of the selected secondary collaborators, or until no addition selected secondary collaborators remain to be processed. In the latter circumstance, either the redirect can be canceled in block 350, or the process can begin anew in block 325 with the selection of the first of the selected secondary collaborators as shown in FIG. 3.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for the timed redirection of a high priority instant message comprising:
transmitting an instant message to a primary recipient; and,
redirecting the instant message to a plurality of secondary recipients in sequence, each of the secondary recipients receiving the redirected instant message one at a time at pre-programmed intervals of time.

2. The method of claim 1, wherein redirecting the instant message to a plurality of secondary recipients in sequence, comprises:
prompting for a list of secondary recipients and a timeout value;
selecting a first one of the secondary recipients and redirecting the instant message to the first one of the secondary recipients; and,
selecting a second one of the secondary recipients and redirecting the instant message to the second one of the secondary recipients while vanishing a display of the redirected message for the first one of the secondary recipients, all in response to an elapsed period of time exceeding the timeout value.

3. The method of claim 1, further comprising cancelling all redirects of the instant message in response to receiving a response from the primary recipient.

4. The method of claim 1, further comprising cancelling all redirects of the instant message in response to receiving a response from one of the secondary recipients.

5. An instant messaging data processing system comprising:
an instant messenger configured for communicative coupling to a plurality of instant messaging recipients;
a directory of the instant messaging recipients; and,
time instant message redirection logic comprising program code enabled to redirect a transmitted instant message to a plurality of secondary ones of the instant messaging recipients in the directory, each of the secondary ones of the instant messaging recipients receiving the redirected instant message one at a time at a pre-programmed interval of time.

6. The system of claim 5, further comprising a redirect control disposed in the instant messenger.

7. The system of claim 6, further comprising a pop-up window responsive to the redirect control, the pop-up window comprising a listing of the instant messaging recipients in the directory and a time field configured to receive a specification of the pre-programmed interval of time.

8. A computer program product comprising a computer usable medium embodying computer usable program code for the timed redirection of a high priority instant message, the computer program product comprising:
computer usable program code for transmitting an instant message to a primary recipient; and,
computer usable program code for redirecting the instant message to a plurality of secondary recipients in sequence, each of the secondary recipients receiving the redirected instant message one at a time at pre-programmed intervals of time.

9. The computer program product of claim 8, wherein the computer usable program code for redirecting the instant message to a plurality of secondary recipients in sequence, comprises:
computer usable program code for prompting for a list of secondary recipients and a timeout value;
computer usable program code for selecting a first one of the secondary recipients and redirecting the instant message to the first one of the secondary recipients; and,
computer usable program code for selecting a second one of the secondary recipients and redirecting the instant message to the second one of the secondary recipients while vanishing a display of the redirected message for the first one of the secondary recipients, all in response to an elapsed period of time exceeding the timeout value.

10. The computer program product of claim 8, further comprising computer usable program code for cancelling all redirects of the instant message in response to receiving a response from the primary recipient.

11. The computer program product of claim 8, further comprising computer usable program code for cancelling all redirects of the instant message in response to receiving a response from one of the secondary recipients.
